(19) United States
(12) Patent Application Publication
(10) Pub. No.: US 2026/0167053 A1
(43) Pub. Date: Jun. 18, 2026

(54) BATTERY DISCHARGING METHOD USING THERMAL ENERGY SYSTEM AND SYSTEM THEREOF

(71) Applicants: Hyundai Motor Company, Seoul (KR); Kia Comporation, Seoul (KR)

(72) Inventors: Yeon Ho Kim, Hwaseong-si (KR); Hochan An, Hwaseong-si (KR); Jeawan Kim, Hwaseong-si (KR); Hoyoung Jeong, Hwaseong-si (KR); Man Hee Park, Hwaseong-si (KR); Yeong Jun Kim, Hwaseong-si (KR); Jae Yeon Kim, Hwaseong-si (KR); Gwi Taek Kim, Hwaseong-si (KR)

(21) Appl. No.: 19/395,078

(22) Filed: Nov. 20, 2025

(30) Foreign Application Priority Data
Dec. 13, 2024 (KR) 10-2024-0185709

(51) Int. Cl. B60L 58/12; B60L 58/27; B60W 60/00; G07C 5/04; H01M 10/42; H01M 10/44

(52) U.S. Cl. CPC B60L 58/12; B60L 58/27; G07C 5/04; H01M 10/443; B60L 2240/12; B60L 2240/545; B60L 2240/662; B60L 2250/26; B60W 60/001; H01M 2010/4271; H01M 2220/20

(57) ABSTRACT

A method for discharging a battery using a thermal energy system includes: collecting status information according to driving an electric vehicle, and when a brake pedal signal is input, determining whether a battery state of charge (SoC) is greater than a threshold value; when the battery SoC is greater than a threshold value, determining whether a high power part of the thermal energy system is operated; and controlling at least one high power part using a thermal energy system in a forced discharge mode by executing a high-SOC brake compensation (HBC) logic.

### CROSS-REFERENCE TO RELATED APPLICATIONS

This application claims priority to and the benefit of Korean Patent Application No. 10-2024-0185709 filed with the Korean Intellectual Property Office on Dec. 13, 2024, the entire contents of which are incorporated herein by reference.

### TECHNICAL FIELD

The present disclosure relates to a battery discharging method using a thermal energy system, and a system thereof, and more particularly, the present disclosure relates to a battery discharging method using a thermal energy system for avoiding a condition in which regenerative braking is not operated due to full charge of a high voltage battery of an electric vehicle.

### BACKGROUND

In general, internal combustion engine vehicles use mechanical friction braking to reduce rotational motion of drive wheels by a frictional force of a disk and caliper when a brake pedal is operated.

In comparison, an electric vehicle (xEV) equipped with a motor and a high voltage battery (hereinafter referred to as “battery”) brakes the vehicle using a combination of mechanical friction braking and regenerative braking. Regenerative braking refers to the process in which a motor acts as a generator by the torque of the driving wheels during coasting and/or braking of a vehicle, and the electric power generated by the motor is used to charge the battery.

As the driving time of an electric vehicle increases, a driver naturally learns a braking sense taking regenerative braking into account and develops habits (or patterns) of operating the brake pedal. Therefore, the driver operates the brake pedal considering the regenerative braking size normally applied to the electric vehicle while driving.

Meanwhile, when a state of charge (SoC) of the battery of the electric vehicle is close to full charge (e.g., over 90%), it does not operate regenerative braking in response to the driver's braking request and decelerates only with friction braking. This may be considered a safety control at the battery management system (BMS) level because excessive charging of the battery through regenerative braking in a fully charged state may have a negative impact on the soundness of the battery.

However, the driver who has learned the braking feel by considering the usual regenerative braking size may be confused by the sudden change in braking feel when regenerative braking is not operated. In particular, there is a problem that if the driver fails to adjust the brake pedal pressure due to the changed braking feel, a very dangerous situation may occur, which may lead to a serious accident.

The information contained in this background section is intended to promote understanding of the background of the disclosure and may include matters that are not conventional art already known to a person of ordinary skill in the field to which this technology belongs.

### SUMMARY

The present disclosure attempts to provide a battery discharge method using a thermal energy system for avoiding a case when regenerative braking is not operated or quickly leaving the same case by obtaining regenerative braking charging capacity according to forced discharge of a battery using a thermal energy system when a battery state of charge (SoC) of an electric vehicle (xEV) is close to full charge, and a system thereof.

An embodiment of the present disclosure provides a method for discharging a battery using a thermal energy system including: collecting status information according to driving an electric vehicle, and when a brake pedal signal is input, determining whether a battery state of charge (SoC) is greater than a threshold value, by a controller; when the battery SoC is greater than a threshold value, determining whether a high power part of the thermal energy system is operated, by the controller; and controlling at least one high power part using a thermal energy system in a forced discharge mode by executing a high-SOC brake compensation (HBC) logic, by the controller.

The controlling of the high power part in a forced discharge mode may include additionally consuming electric power of the battery by forcedly operating at least one high power part that is not used according to whether a thermal management mode of the thermal energy system is operated, and increasing power consumption of the battery by performing inefficiency control on the high power part that is in operation.

The HBC logic may include: determining whether the battery SoC is greater than a threshold value and whether a battery temperature is within an allowable temperature range; and performing a first HBC logic considering a battery conditioning mode of the thermal energy system when the battery SoC is greater than the threshold value and the battery temperature is out of the allowable temperature range.

The performing of a first HBC logic may include: performing a battery conditioning mode by the controller; performing high power part inefficiency control by the controller when the battery SoC is greater than a first charge reference; and performing the high power part inefficiency control for a predetermined time, and when the battery SoC is greater than a second charge reference, performing discharge control on the non-operated high power part by the controller.

The performing of discharge control on the non-operated high power part may include, when the battery conditioning mode is performed, operating a non-operated coolant electric heater during cooling the battery, and increasing an operation amount of the operating electric compressor.

Adding discharge control on the non-operation high power part may include: when the battery conditioning mode is performed, increasing an operation amount of a coolant electric heater operated when the temperature of the battery increases, and operating an electric compressor that is not operated.

The HBC logic may further include, when the battery SoC is greater than the threshold value and the battery temperature is within an allowable temperature range, determining as that the battery conditioning is not needed, and performing a second HBC logic for performing a forced discharge on a high power part that is not operated.

The performing of a second HBC logic may include: when an outside temperature is not greater than a high temperature reference value, operating a coolant electric heater for increasing the temperature of the battery and a radiator by the controller; and when the outside temperature is greater than the high temperature reference value, operating the coolant electric heater for increasing the temperature of the battery and a chiller by the controller to increase the discharged amount of the coolant electric heater by a cooling amount through the chiller.

Another embodiment of the present disclosure provides a system for discharging a battery using a thermal energy system including: a data detector for collecting status information according to driving an electric vehicle; a thermal energy system for managing operation temperatures of a motor and the battery; and a controller for, when a battery charged state collected as the status information is greater than a threshold value, performing forced discharge control of the battery using the thermal energy system to prevent an operation of regenerative braking from being limited.

The data detector may collect the status information including at least one of a battery state of charge (SoC), a battery temperature, an outside temperature, a vehicle speed, an accelerating signal, a braking signal, and an operation state of the thermal energy system.

The thermal energy system may selectively circulate refrigerant and coolant for thermal management of an electrical component including a drive motor and an inverter, a battery, and an autonomous driving controller.

The controller may additionally consume electric power of the battery by forcedly operating at least one high power part that is not operated by performing a high-SOC brake compensation (HBC) logic when performing forced discharge control on the battery, and may increase power consumption of the battery by performing inefficiency control on the high power part that is operated.

According to the embodiment, when the battery state of charge (SoC) of an electric vehicle is close to full charge, forcible discharge of battery using a thermal energy system may be performed to reduce changes in braking feel due to sudden failure of regenerative braking and prevent the risk of braking failure.

According to the embodiment, there is an effect of securing the battery discharged amount by operating the energy system or selectively operating the non-operated high power part depending on whether battery conditioning is controlled when the battery is forcedly discharged.

According to the embodiment, the starting point for forcedly discharging a battery based on the battery temperature may be set to be equal to or lower than the regenerative braking non-operating reference by the driver, thereby having the effect of early avoiding (escaping from) or preventing an undesirable regenerative braking operation non-operated situation.

### BRIEF DESCRIPTION OF THE DRAWINGS

FIG. 1 shows a block diagram on a battery discharging system using a thermal energy system according to an embodiment.

FIG. 2 shows a structure of an HBC operation circuit of a thermal energy system according to an embodiment.

FIG. 3 shows a flowchart on a method for controlling regenerative braking of a vehicle according to an embodiment.

FIG. 4 shows a flowchart on an HBC logic according to an embodiment.

### DETAILED DESCRIPTION OF ILLUSTRATIVE EMBODIMENTS

In the following detailed description, only certain embodiments of the present disclosure have been shown and described, simply by way of illustration.

The terminology used herein is for the purpose of describing particular embodiments only and is not intended to be limiting of the present disclosure. As used herein, the singular forms are intended to include the plural forms as well, unless the context clearly indicates otherwise. As used herein, the term “comprises” and/or “comprising” refers to the presence of specified features, integers, steps, acts, elements and/or components, but it should also be understood that it does not exclude a presence or an addition of one or more other features, integers, steps, acts, components, and/or groups thereof. As used herein, the term “and/or” includes any one or all combinations of one or more related items.

Throughout the specification, terms such as first, second, “A”, “B”, “(a)”, “(b)”, and the like will be used only to describe various elements, and are not to be interpreted as limiting these elements. These terms are only for distinguishing the constituent elements from other constituent elements, and nature or order of the constituent elements is not limited by the term.

It is to be understood that when one component is referred to as being “connected” or “coupled” to another component, it may be connected or coupled directly to the other component or be connected or coupled to the other component with a further component intervening therebetween. It is to be understood that when one component is referred to as being “connected or coupled directly” to another component, it may be connected to or coupled to the other component without another component intervening therebetween.

The terms used herein are only used to describe certain embodiments and are not intended to limit the present disclosure. Singular expressions are intended to include plural forms as well, unless the context clearly dictates otherwise.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. The controller may control operation of units, modules, parts, devices, or the like, as described herein. Moreover, it is understood that the below methods may be executed by an apparatus comprising the controller in conjunction with one or more other components, as would be appreciated by a person of ordinary skill in the art.

A method for discharging a battery using a thermal energy system according to an embodiment, and a system thereof will now be described with reference to accompanying drawings.

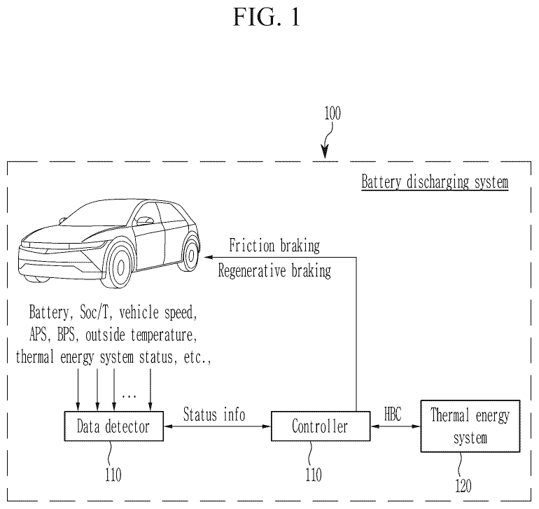

FIG. 1 shows a block diagram on a battery discharging system using a thermal energy system according to an embodiment.

Referring to FIG. 1, the battery discharging system 100 using a thermal energy system according to an embodiment includes: a data detector 110 for collecting status information of a vehicle from various sensors according to operation of an electric vehicle; a thermal energy system 120 for maintaining operation temperatures of a motor and a battery; and a controller 130 for performing forced discharge control of a battery using the thermal energy system 120 to avoid limiting an operation of regenerative braking when a state of charge (SoC) of the battery collected as the status information exceeds a threshold value close to full charge.

In an embodiment, the vehicle means any types of electric vehicles equipped with a motor and a battery and capable of regenerative braking. For example, the vehicles include an electric vehicle (EV), a hybrid electric vehicle (HEV), a plug-in HEV (PHEV), an extended range electric vehicle (EREV), etc.

The data detector 110 may detect status information including a battery SoC (State of Charge), a battery temperature (T), an outside temperature, a vehicle speed, an accelerator position sensor (APS) signal, a braking (or brake pedal sensor (BPS) signal, a thermal energy system operating status, etc., and may transmit the detected status information to the controller 130.

The controller 130 may control an overall operation of the battery discharging system 100 using the energy system and may include at least one program and data for the control.

The controller 130 may store high-SOC brake compensation (HBC) logic for performing forced discharge control of the battery using the thermal energy system 120. The HBC logic is intended to secure the battery's spare capacity (hereinafter referred to as “regenerative braking capacity”) that may be charged by regenerative braking by forcibly operating high power parts used in heat energy management of the electric vehicle.

This may enable the controller 130 to execute the HBC logic to secure regenerative braking capacity that may be charged to the battery, and may have the effect of early avoiding (or escaping from) or preventing a situation in which the operation of regenerative braking that the vehicle and/or driver does not want is restricted (a situation in which regenerative braking is not operated). This effect may be selectively provided by system configuration of a driver who does not want to execute the corresponding HBC logic.

The thermal energy system 120 may be operated by the HBC logic according to a forced discharge control of the battery by the controller 130.

The thermal energy system 120, also known as a heat pump system or a thermal management system, may provide a thermal management function for maintaining not only cooling and heating of electric vehicles, but also electrical components (PE: Power Electric), including drive motors and inverters, batteries, and autonomous driving controllers at optimal operating temperatures.

The thermal energy system 120 may have a circuit structure for selectively circulating refrigerant and coolant through a closed circuit to provide a thermal management function of the vehicle.

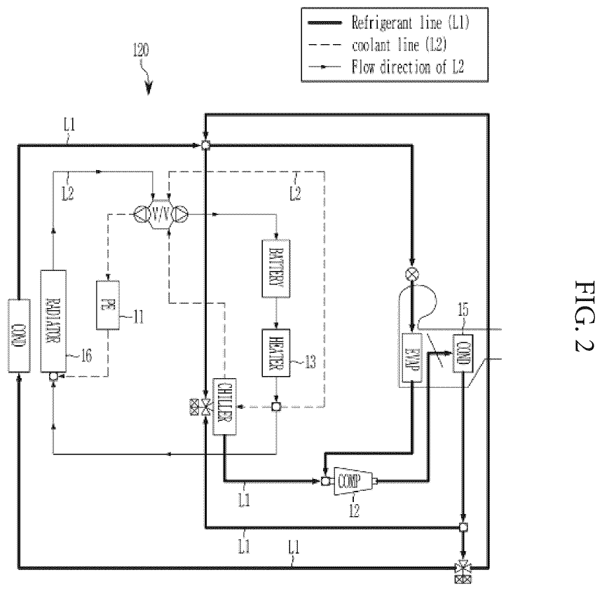

For example, FIG. 2 shows a structure of an HBC operation circuit of a thermal energy system according to an embodiment.

Referring to FIG. 2, the thermal energy system 120 includes a high power part and a low power part consuming electric power of a battery. The high power part may include an electrical component (PE: Power Electric) 11 including a vehicle driving motor and an inverter; an electric compressor 12 for compressing a refrigerant; a coolant electric heater 13 for heating a coolant; an internal condenser 15 for condensing the refrigerant; a radiator 16 for heat-exchanging the coolant with the outside air; and a chiller 17. The electrical component 11 includes at least one of a motor, an inverter, and an autonomous driving controller.

The low power part may include a valve (ex: 3way to 5way V/V) for connecting, blocking, or switching the flow of a refrigerant line L1 and a coolant line L2 according to a thermal management mode of the thermal energy system 120, such as cooling, heating, or dehumidification, a coolant pump, a window glass heater, etc. The rest may refer to existing known heat pump technologies.

The controller 130 may execute the HBC logic for forcibly operating at least one high power part that is not currently operated depending on whether a thermal management mode of the thermal energy system 120 is operated to consume additional power, and performing an inefficiency control of the high power part in operation to maximize (or increase) power consumption.

For example, regarding the HBC operating circuit of FIG. 2, the thick solid line may represent the refrigerant line L1 through which the refrigerant flows, the thin dotted line may represent the coolant line L2 through which the coolant does not flow, and the thin solid line may represent the coolant line L2 through which the coolant flows. When the battery temperature (T) is within the normal temperature range and battery conditioning is not required, the controller 130 may execute the HBC logic to forcibly operate the coolant electric heater 13 and the radiator 16 to discharge the battery.

The controller 130 may be implemented as one or more processors operable by a predetermined program, and the predetermined program may be programmed to perform respective stages of a method for controlling regenerative braking of a vehicle according to an embodiment.

The method for controlling regenerative braking of the vehicle will be described in more detail with reference to the drawings below.

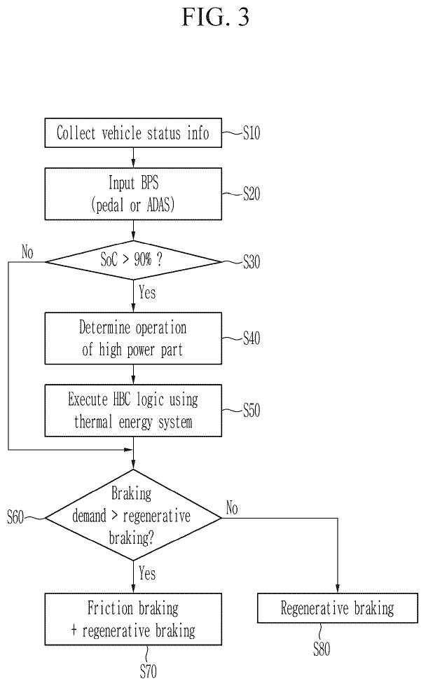

FIG. 3 shows a flowchart on a method for controlling regenerative braking of a vehicle according to an embodiment.

Referring to FIG. 3, the data detector 110 of the battery discharging system 100 according to an embodiment collects status information according to the operation of the vehicle S10. Status information collected by the data detector 110 is transmitted to the controller 130.

When the brake pedal signal (BPS) according to the status information during operating the vehicle is input (S20), the controller 130 determines whether the battery SoC exceeds a threshold value (ex: 90%) (S30). The brake pedal signal (BPS) may be input from the operation of the brake pedal by the driver, the advanced driver assistance system (ADAS), or the autonomous driving controller. The threshold value may be set as an entry condition into the regenerative braking non-operation mode based on the battery SoC.

The controller 130 may determine whether the high power parts of the thermal energy system 120 are operated (S40) if the battery SoC exceeds the threshold value (Yes in S30).

The controller 130 may execute the HBC logic to allow at least one high power part in the thermal energy system 120 to operate in a forced discharge mode, thereby securing the regenerative braking capacity of the battery (S50). The controller 130 may forcibly operate at least one high power part that is not currently operating, depending on whether the thermal energy system 120 is operated in the thermal management mode, thereby consuming additional electric power of the battery, and maximizing power consumption by performing inefficiency control on the high power part that is currently operating.

The controller 130 may determine whether the braking demand is greater than the regenerative braking amount while the regenerative braking capacity is secured (S60). That is, the controller 130 may compare whether the braking demand (e.g., total braking amount) determined based on the brake pedal signal (BPS) may be satisfied by the regenerative braking amount (e.g., possible regenerative braking amount) of the current vehicle.

The controller 130 may brake the vehicle using a combination of friction braking and regenerative braking (S70) if the braking demand amount is greater than the regenerative braking amount (Yes in S60).

The controller 130 may brake the vehicle using regenerative braking (S80) if the braking demand amount is less than or equal to the regenerative braking amount (No in S60).

If the SoC is equal to or less than the threshold value (No in S30), the controller 130 may determine as that the regenerative braking capacity of the battery is sufficiently secured, and it may perform the S60 to S80.

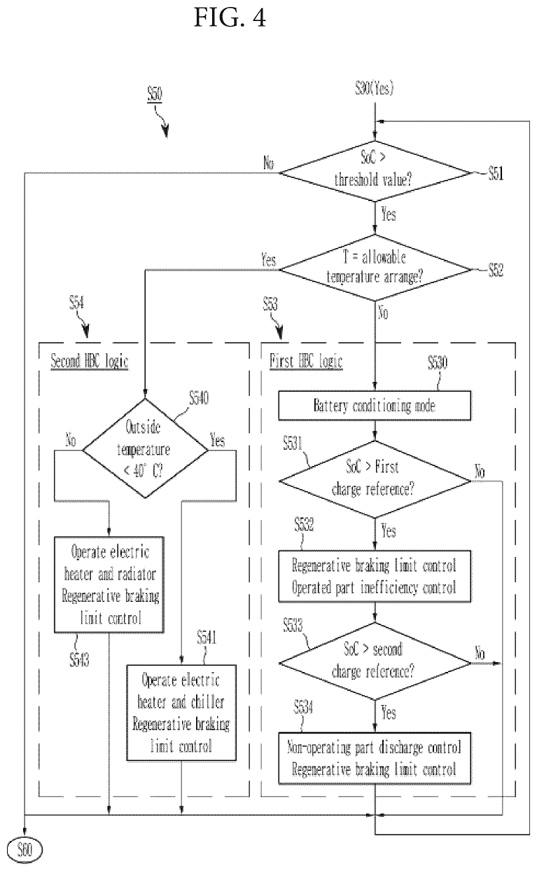

The flow of the HBC logic for controlling forced discharge of the battery at S50 will now be described in detail with reference to FIG. 4.

FIG. 4 shows a flowchart on an HBC logic according to an embodiment.

Referring to FIG. 4, the HBC logic is executed if the battery SoC is greater than a threshold value (ex: 90%) (Yes in S30).

The controller 130 may determine whether the battery SoC collected as real-time status information is greater than the threshold value (ex: 90%) (S51) and whether the battery temperature (T) is within the allowable temperature range (ex: 20° C. to 40° C.) (S52).

If the battery SoC is equal to or less than a threshold value (ex: 90%) (No in S51), the controller 130 may limit an exclusive use of regenerative braking and may perform regenerative braking limit control with a reduced amount of the regenerative braking amount together with friction control. The regenerative braking limit control represents reducing the regenerative braking amount for 100% of the braking demand amount and increasing the friction braking amount by the amount of reduction. Therefore, the battery charging amount caused by regenerative braking may be reduced while allowing partial regenerative braking.

The controller 130 may execute a first HBC logic considering battery conditioning of the thermal energy system 120 (S53) if the battery SoC is greater than a threshold value (ex: 90%) (Yes in S51) and the battery temperature (T) is out of an allowable temperature range (ex: 20° C. to 40° C.) (No in S52).

The first HBC logic may be a battery forced discharging method performed under the operating condition of the battery conditioning mode of the thermal energy system 120.

That is, the controller 130 runs a battery conditioning mode (S530). The battery conditioning mode represents thermally managing the battery temperature (T) within the allowable temperature range (ex: 20° C. to 40° C.) to maintain battery performance. The controller 130 may cool the battery using the electric compressor 12 when the battery temperature (T) is greater than the allowable temperature upper limit of 40° C. through the thermal energy system 120, and it may heat the battery using the coolant electric heater 14 when the battery temperature (T) is lower than the allowable temperature lower limit of 20° C.

The controller 130 performs high power part inefficiency control (S532) if the battery SoC is greater than a first charge reference (ex: 94%) that is set to be greater than the threshold value (Yes in S531).

When the battery conditioning mode is performed, the power consumption of the battery decreases and the SOC of the battery decreases depending on the operation of the electric compressor 12 or the electric heater 14. However, if the decrease in the SOC of the battery is not sufficient (e.g., if the SOC is greater than the first charge reference (ex: 94%)), the controller 130 may perform high power part inefficiency control.

In an embodiment, the high power part inefficiency control may represent increasing power consumption of the battery by controlling at least one of the operating high power parts more inefficiently than necessary.

For example, the controller 130 may increase energy consumption of the electric compressor 12 or the coolant electric heater 13, which are operated for cooling the battery or increasing the battery temperature during driving using motor, more than necessary. Therefore, as the discharged amount of the battery increases, an SOC margin (i.e., regenerative braking capacity) of the battery may be secured.

The controller 130 performs the high power part inefficiency control for a predetermined period of time, and if the measured battery SoC is greater than a second charge reference (ex: 92%) set based on the target discharged amount (ex: −2%) (Yes in S533), it may determines that the current forced discharge speed is insufficient, and may add discharge control for the non-operating high power part (S534).

For example, assuming that the target discharged amount when performing a forced discharge for a predetermined period of time is −2%, the target discharge speed may be satisfied when it is equal to or less than 92%, which is the amount obtained by subtracting −2% from the previous battery SoC of 94%.

However, the forced discharge speed may vary depending on the vehicle driving circumstances. Therefore, when the high power part inefficiency control is implemented, and the battery SoC is greater than 92% (Yes in S533), the forced discharge speed is slow so the regenerative braking may be limited when the amount of charged energy due to regenerative braking is still large. Therefore, the controller 130 determines that the discharged amount is insufficient with high power part inefficiency control, and secures an additional SOC margin through additional operation of the non-operating part.

Here, when performing additional operation on the non-operation part, the controller 130 may further consider the battery cooling and battery temperature-increasing operation conditions of the thermal energy system 120.

For example, when the battery conditioning mode is executed, the controller 130 may operate the coolant electric heater 13 which is not in operation during the battery cooling, and may increase the operation amount of the electric compressor 12, which is in operation, to cool the heat generated by the electric heater 13. That is, the controller 130 may operate the electric heater 13 and may increase cooling capacity of the electric compressor 12 to secure additional SOC margin of the battery.

The controller 130 may increase the operation amount of the coolant electric heater 13 that is operating when the temperature of the battery increases, and it may operate the electric compressor 12 that is not in operation to dissipate the heat generated by the electric heater 13. That is, the controller 130 may increase the operation amount of the electric heater 130 and may operate the electric compressor 12 to secure additional SOC margin of the battery.

The controller 130 may additionally discharge the battery due to inefficiency operation of the motor and the coolant pump.

The controller 130 may perform regenerative braking limit control until the battery SoC reduces to be equal to or less than a threshold value (ex: 90%).

The controller 130 may perform the regenerative braking limit control if the battery SoC is equal to or less than the first charge reference (ex: 94%) in S531 (No in S531) or if the battery SoC is equal to or less than a second charge reference in step S533 (No in S533).

If the battery temperature (T) is within the allowable temperature range (ex: 20° C. to 40° C.) in S52 (Yes in S52), the controller 130 may determine as that the battery conditioning mode is unnecessary, and may execute the second HBC logic for performing a forced discharge on the non-operating high power part (S54).

The second HBC logic may be a battery forced discharging method performed under the condition where battery conditioning of the thermal energy system 120 is not operated.

The controller 130 may compare an outside temperature collected as status information in the second HBC mode with the reference value of high temperature (ex: 40° C.) (S540).

If the outside temperature is equal to or less than the reference value of high temperature (ex: 40° C.) (Yes in S540), the controller 130 may simultaneously operate the coolant electric heater 13 and the radiator 16 for increasing the battery temperature (S541). That is, the battery may be discharged through the coolant electric heater 13, and the radiator 16 may be operated to dissipate the heat generated by the electric heater 13 since the outside temperature condition is not high.

If the outside temperature is greater than the reference value of high temperature (ex: 40° C.) (Yes in S540), the controller 130 may operate the coolant electric heater 13 and the chiller 17 for increasing the battery temperature (S543). That is, the chiller 17 may be used to discharge the battery through the coolant electric heater 13 and dissipate the heat generated by the electric heater 13 in the condition of high outside temperature. This control strategy is advantageous in securing the regenerative braking capacity (or battery margin) of the battery as the discharged amount of the coolant electric heater 13 may be increased by the increased amount of the cooling through the chiller 17 in the condition where the outside temperature is high.

The controller 130 may perform regenerative braking limit control until the battery SoC is reduced to be less than the threshold value (ex: 90%) after S541 or S543.

The above describes an embodiment, but various modifications are possible.

For example, in the above-described embodiment, numerical values such as the threshold value used in the HBC logic, first and second charge references, the target discharged amount, an allowable temperature range, and a high temperature reference value are not limited thereto, and they may be optimized by learning through tests or pre-designated algorithms (e.g., programs and probability models).

Particularly, the threshold value (ex: 90%) may be a value for substantially determining the forced discharge starting point of the battery, may not be limited to 90%, and may be variably set by the driver's desired user interface.

If the threshold value is set to be 90%, the controller 130 may start a forced battery discharge when the battery SoC is greater than 90%, and may quickly escape from the regenerative braking non-operation situation.

When the threshold value is set to be 85% which is less than 90%, the controller 130 may have the advantage of preventing (avoiding) a regenerative braking non-operation situation by starting the forced battery discharge when the battery SoC is greater than 85%.

According to an embodiment, when the battery state of charge (SoC) of an electric vehicle is close to full charge, the battery forcibly discharged using a thermal energy system may be performed to reduce changes in braking feel due to sudden regenerative braking failure and prevent the risk of braking failure.

There is an effect of securing the battery discharged amount by controlling the inefficiency of the operating high power part of the energy system when the battery is forcibly discharged, or by selectively operating the non-operating high power part.

The driver may set the forced discharge starting point of the battery based on the battery temperature to be equal to or less than the regenerative braking non-operation reference, which has the effect of early avoidance (escape) or prevention of an undesirable regenerative braking operation non-operated situation.

The embodiments of the present disclosure described above are not only implemented by the device and the method, but may be implemented by a program for realizing functions corresponding to the configuration of the embodiments of the present disclosure or a recording medium on which the program is recorded.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: battery discharging system
110: data detector
120: thermal energy system
130: controller
L1, L2: refrigerant line, coolant line
11: electrical component (PE)
12: electric compressor
13: coolant electric heater
15: internal condenser
16: radiator
17: chiller

What is claimed is:

1. A method for discharging a battery using a thermal energy system, the method comprising:
collecting status information during driving of an electric vehicle;
determining, by a controller and when a brake pedal signal is input, whether a battery state of charge (SoC) is greater than a threshold value;
determining, by the controller and when the battery SoC is greater than the threshold value, whether one or more high power parts of the thermal energy system are currently being operated; and
controlling, by the controller, the one or more high power parts using the thermal energy system in a forced discharge mode by executing a high-SoC brake compensation (HBC) logic.

2. The method of claim 1, wherein controlling the one or more high power parts in the forced discharge mode comprises:
additionally consuming electric power of the battery by forcedly operating a first high power part of the one or more high power parts that is not being used according to whether a thermal management mode of the thermal energy system is operated; and
increasing power consumption of the battery by performing inefficiency control on a second high power part of the one or more high power parts that is in operation.

3. The method of claim 1, wherein executing the HBC logic comprises:
determining whether the battery SoC is greater than the threshold value;
determining whether a battery temperature is within an allowable temperature range; and
performing a first HBC logic comprising a battery conditioning mode of the thermal energy system when the battery SoC is greater than the threshold value and the battery temperature is out of the allowable temperature range.

4. The method of claim 3, wherein performing the first HBC logic comprises:
performing, by the controller, the battery conditioning mode;
performing, by the controller, high power part inefficiency control when the battery SoC is greater than a first charge reference; and
performing, by the controller, after performing the high power part inefficiency control for a predetermined time and when the battery SoC is greater than a second charge reference, discharge control on a non-operated high power part.

5. The method of claim 4, wherein performing the discharge control on the non-operated high power part comprises, when the battery conditioning mode is performed:
operating a non-operated coolant electric heater during cooling the battery; and
increasing an operation amount of an operating electric compressor.

6. The method of claim 4, wherein performing the discharge control on the non-operation high power part comprises, when the battery conditioning mode is performed:
increasing an operation amount of a coolant electric heater operated when a temperature of the battery increases; and
operating an electric compressor that is not being currently operated.

7. The method of claim 3, wherein executing the HBC logic further comprises, when the battery SoC is greater than the threshold value and the battery temperature is within the allowable temperature range:
determining that the battery conditioning mode is not needed; and
performing a second HBC logic for performing a forced discharge on a high power part of the one or more high power parts, which is determined by the controller to not be currently operated.

8. The method of claim 7, wherein performing the second HBC logic comprises:
when an outside temperature is not greater than a high temperature reference value, operating, by the controller:
a coolant electric heater for increasing the battery temperature; and
operating a radiator; and
when the outside temperature is greater than the high temperature reference value, operating, by the controller:
the coolant electric heater for increasing the battery temperature; and
a chiller to increase a discharged heat amount of the coolant electric heater by a cooling amount through the chiller.

9. A system for discharging a battery using a thermal energy system, the system comprising:
a data detector configured to collect status information during driving of an electric vehicle, wherein the status information comprises a battery state of charge (SoC);
the thermal energy system configured to manage operation temperatures of a motor and the battery; and
a controller configured to, when the battery SoC is greater than a threshold value, performing forced discharge control of the battery using the thermal energy system to prevent an operation of regenerative braking from being limited.

10. The system of claim 9, wherein the status information further comprises at least one of:
a battery temperature;
an outside temperature;
a vehicle speed;
an accelerating signal;
a braking signal; and
an operation state of the thermal energy system.

11. The system of claim 9, wherein the thermal energy system is further configured to selectively circulate refrigerant and coolant for thermal management of:
an electrical component including a drive motor and an inverter;
the battery; and
an autonomous driving controller.

12. The system of claim 9, wherein the controller is further configured to:
additionally consume electric power of the battery by forcedly operating a first high power part that is not currently being operated by performing a high-SoC brake compensation (HBC) logic when performing the forced discharge control on the battery; and
increase power consumption of the battery by performing inefficiency control on a second high power part that is currently being operated.

13. A method for managing regenerative braking of an electric vehicle, the method comprising:
making a first determination, by a controller of the electric vehicle and in response to receipt of a brake pedal input signal, that a battery of the electric vehicle has a state of charge (SoC) that is greater than a threshold value;
making a second determination, by the controller, whether a plurality of high power parts of a thermal energy system of the electric vehicle are currently being operated; and
operating one or more high power parts of the plurality of high power parts in a forced discharge mode based on the first determination and the second determination.

14. The method of claim 13, wherein operating the one or more high power parts in the forced discharge mode comprises:
operating a first high power part of the one or more high power parts to increase power consumption from the battery, wherein the first high power part is determined by the second determination to previously not be in operation; and
performing inefficiency control of a second high power part of the one or more high power parts to further increase the power consumption from the battery, wherein the second high power part is determined by the second determination to currently be in operation.

15. The method of claim 13, wherein operating the one or more high power parts in the forced discharge mode comprises:
making a third determination, by the controller, of whether a temperature of the battery is within an allowable temperature range.

16. The method of claim 15, wherein operating the one or more high power parts in the forced discharge mode further comprises, when the temperature is within the allowable temperature range:
making a fourth determination, by the controller, of whether an outside temperature is greater than an outside temperature reference value.

17. The method of claim 16, wherein operating the one or more high power parts in the forced discharge mode further comprises, when the outside temperature is greater than the outside temperature reference value:
operating, by the controller, an electric heater of the thermal energy system; and
operating, by the controller, a chiller of the thermal energy system.

18. The method of claim 16, wherein operating the one or more high power parts in the forced discharge mode further comprises, when the outside temperature is not greater than the outside temperature reference value:
operating an electric heater of the thermal energy system; and
operating a radiator of the thermal energy system.

19. The method of claim 15, wherein operating the one or more high power parts in the forced discharge mode further comprises, when the temperature is not within the allowable temperature range:
executing a battery conditioning mode of the thermal energy system.

20. The method of claim 19, wherein executing the battery conditioning mode comprises:
making a fourth determination, by the controller, that the SoC of the battery is greater than a first charge reference value;
performing, by the controller and based on the fourth determination, inefficiency control of a first high power part of the one or more high power parts to increase power consumption from the battery, wherein the first high power part is determined by the second determination to currently be in operation;
making a fifth determination, by the controller and after performing the inefficiency control, that the SoC of the battery is greater than a second charge reference value; and
operating, by the controller and based on the fifth determination, a second high power part of the one or more high power parts to further increase power consumption from the battery, wherein the second high power part is determined by the second determination to previously not be in operation.
